(19) United States
(12) Patent Application Publication
(10) Pub. No.: US 2022/0122058 A1
(43) Pub. Date: Apr. 21, 2022

(54) SERVER, PAYMENT METHOD, AND PAYMENT PROGRAM

(71) Applicant: GINKAN, INC., TOKYO (JP)

(72) Inventor: TOMOCHIKA KAMIYA, TOKYO (JP)

(21) Appl. No.: 17/561,746

(22) Filed: Dec. 24, 2021

Related U.S. Application Data
(63) Continuation of application No. PCT/JP2020/023841, filed on Jun. 17, 2020.

(30) Foreign Application Priority Data
Jun. 24, 2019 (JP) 2019-116381

(51) Int. Cl. G06Q 20/32; G06Q 20/38; G06Q 30/02

(52) U.S. Cl. CPC G06Q 20/3278; G06Q 30/0207; G06Q 20/381; G06Q 20/3276

(57) ABSTRACT

To provide a technology for facilitating payments and enabling customer relationship management. A server that is connected via a network to a customer terminal and a retailer terminal, the server comprising: a screen generation unit that, on the basis of retailer ID, number of people, and price, generates a scan code for use in making a payment, and provides a scan code issuance screen including the scan code; and an information updating unit that stores a customer ID in a visit history information storage unit in association with a retailer ID, visit date/time, price, and number of people obtained by the customer terminal scanning the scan code.

### TECHNICAL FIELD

The present invention relates to a server and a payment method, and a payment program.

### BACKGROUND ART

It is known that customers make a payment for food and drink charges using a credit card or the like in eating and drinking establishments such as a cafeteria, a restaurant, or the like.

As a system related to such a payment, Japanese Unexamined Patent Application Publication No. 2019-74895 (PLT 1) describes the following: “A payment system 1 including a drink order placement screen for accepting input of food and drink information regarding ordered food and drink; a drink order reception unit for acquiring from a storage unit a food and drink unit price, which is a unit price of the food and drink, on the basis of the entered food and drink information; a food order reception unit and a stationery order reception unit; a usage application unit for calculating a total charge by adding the acquired food and drink unit price; and a usage application unit for outputting the calculated total charge, the payment system 1 comprising a usage time input unit for acquiring usage time during which a user uses or used an area in a shop, and a usage application unit for calculating a time-based usage charge based on a preset time-based usage unit price and the usage time, wherein the usage application unit is configured to calculate a total charge including the food and drink unit price and the time-based usage charge.”

### Citation List

### Patent Literature

[PTL 1] Japanese Unexamined Patent Application Publication No. 2019-74895

### SUMMARY OF THE INVENTION

### Problems to be Solved by the Invention

A technology described in Patent Literature 1 allows for calculation of a total charge by adding a food and drink unit price. The technology described in Patent Literature, however, does not consider acquisition of a date when a customer last visited a shop, and has a problem that customer relationship management is difficult, the customer relationship management being intended to encourage the customer to visit the shop from next time onward.

An object of the present invention is to provide a technology that facilitates payments and enables customer relationship management.

### Means for Solving the Problems

A brief description of typical inventions of those disclosed in the present application is given below.

An embodiment of the present invention is a server that is connected to a customer terminal and a retailer terminal via a network, the server including a screen generation unit that, on the basis of retailer ID, number of people, and price, generates a scan code for use in making a payment, and provides a scan code issuance screen including the scan code. The server also includes an information updating unit that stores a customer ID in a visit history information storage unit in association with the retailer ID, visit date/time, price, and number of people obtained by the customer terminal scanning the scan code.

In addition, another embodiment of the present invention is a payment method in a server that is connected to a customer terminal and a retailer terminal via a network, the method including a screen generation step of a screen generation unit generating a scan code for use in making a payment on the basis of retailer ID, number of people, and price, and providing a scan code issuance screen including the scan code. The method also includes an information updating step of an information updating unit storing a customer ID in a visit history information storage unit in association with a retailer ID, visit date/time, price, and number of people obtained by the customer terminal scanning the scan code.

In addition, other embodiment of the present invention is a payment program to be run by a computer of a server that is connected to a customer terminal and a retailer terminal via a network, the payment program causing the computer to perform a screen generation step of a screen generation unit generating a scan code for use in making a payment on the basis of retailer ID, number of people, and price and providing a scan code issuance screen including the scan code. The payment program also causes the computer to perform an information updating step of an information updating unit storing a customer ID in a visit history information storage unit in association with a retailer ID, visit date/time, price, and number of people obtained by the customer terminal scanning the scan code.

### Effect of the Invention

A brief description of effects to be achieved by typical inventions of those disclosed in the present application is given below.

According to one embodiment of the present invention, it is possible to facilitate payments and enable customer relationship management.

### BRIEF DESCRIPTION OF DRAWINGS

FIG. 1 is a diagram illustrating an overview of an overall configuration example of a payment system in a first embodiment of the present invention.

FIG. 2 is a diagram illustrating an overview of a configuration example of retailer information stored in a retailer information storage unit of a server in the first embodiment of the present invention.

FIG. 3 is a diagram illustrating an overview of a configuration example of visit history information stored in a visit history information storage unit of the server in the first embodiment of the present invention.

FIG. 4 is a diagram illustrating an overview of a configuration example of a usage information input screen to be displayed on a display of a retailer terminal in the first embodiment of the present invention.

FIG. 5 is a diagram illustrating an overview of a configuration example of a passcode input screen to be displayed on the display of the retailer terminal in the first embodiment of the present invention.

FIG. 6 is a diagram illustrating an overview of a configuration example of a scan code issuance screen to be displayed on the display of the retailer terminal in the first embodiment of the present invention.

FIG. 7 is a diagram illustrating an overview of a configuration example of a confirmation screen to be displayed of a display on a customer terminal in the first embodiment of the present invention.

FIG. 8 a diagram illustrating an overview of a configuration example of a completion screen to be displayed on the display of the customer terminal in the first embodiment of the present invention.

FIG. 9 is a diagram illustrating an overview of overall processing of the payment system in the first embodiment of the present invention.

FIG. 10 is a diagram illustrating an overview of an overall configuration example of a payment system in a second embodiment of the present invention.

FIG. 11 is a diagram illustrating an overview of retailer information stored in a retailer information storage unit in the second embodiment of the present invention.

FIG. 12 is a diagram illustrating an overview of a configuration example of check-in information stored in a check-in information storage unit of a server in the second embodiment of the present invention.

FIG. 13 is a diagram illustrating an overview of a configuration example of detail information stored in a detail information storage unit of the server in the second embodiment of the present invention.

FIG. 14 is a diagram illustrating an overview of a configuration example of payment information stored in a payment information storage unit of the server in the second embodiment of the present invention.

FIG. 15 is a diagram illustrating an overview of a configuration example of a card information input screen to be displayed on a display of a customer terminal in the second embodiment of the present invention.

FIG. 16 is a diagram illustrating an overview of overall processing of the payment system in the second embodiment of the present invention.

FIG. 17 is a diagram illustrating an overview of overall processing of a payment system in a third embodiment of the present invention.

FIG. 18 is a diagram illustrating an overview of food and drink take-out information in a shop displayed on a customer terminal of a fourth embodiment of the present invention.

FIG. 19 is a diagram illustrating an overview of a configuration example of visit count information based on visit date/time stored in a visit history information unit of a server in a fifth embodiment of the present invention.

### MODES FOR CARRYING OUT THE INVENTION

In the following, a description is given of embodiments of the present invention with reference to the drawings. It is to be noted that in principle, the same portions are denoted by the same reference numerals in all figures for describing the embodiments, and a repeated description thereof is omitted where appropriate.

### First Embodiment

### Overall Configuration

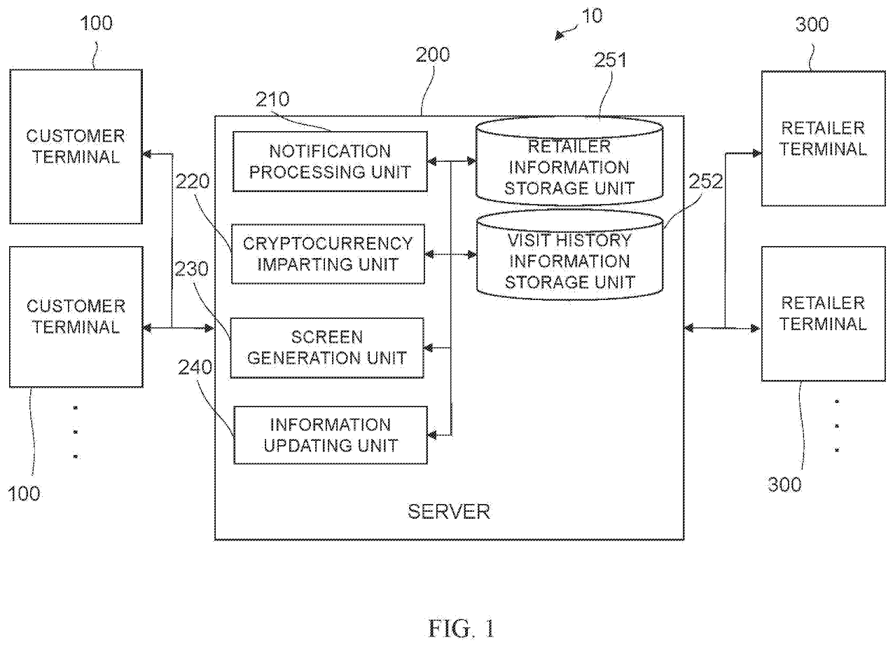

FIG. 1 is a diagram illustrating an overview of an overall configuration example of a payment system in a first embodiment of the present invention. As illustrated in FIG. 1, a payment system 10 includes a customer terminal 100, a server 200 connected to the customer terminals 100 via a network, and a retailer terminal 300 connected to the server 200 via the network.

In addition, predetermined hardware and software are implemented in the customer terminal 100, the server 200, and the retailer terminal 300. For example, the customer terminal 100, the server 200, and the retailer terminal 300 each include a processor or a memory or the like. Execution of a program by the processor on the memory causes a computer in each of the customer terminal 100, the server 200, and the retailer terminal 300 to function as the payment system 10.

In addition, the customer terminal 100 and the retailer terminal 300 are each provided with a touch panel to accept various types of inputs.

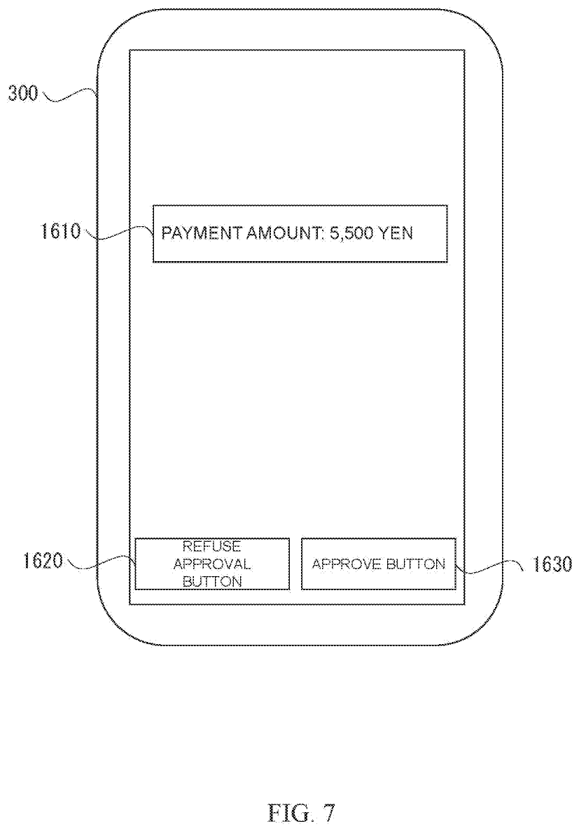

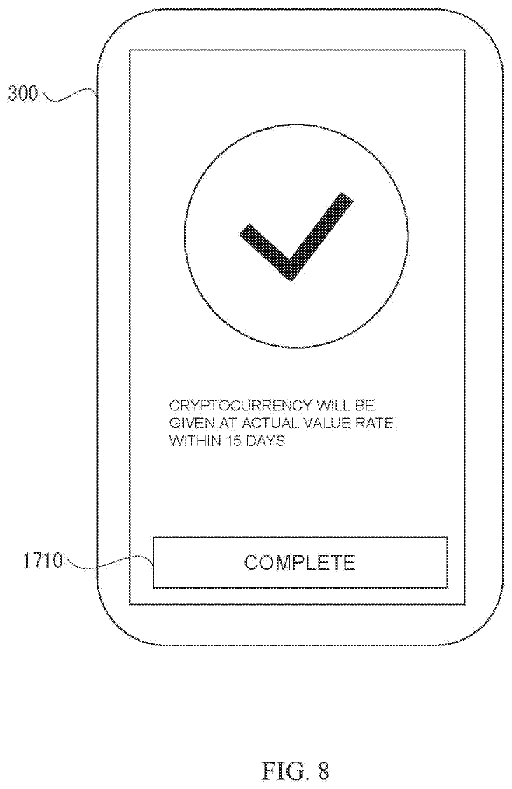

The customer terminal 100 has an application for making a payment process installed in advance, the application for displaying a confirmation screen (to be described below, FIG. 7 and a completion screen (to be described below, FIG. 8). The customer terminal 100 or the application run by the customer terminal 100 requests the server 200 for Web data, the Web data being HTML data for displaying an advertisement or a coupon, image data for displaying a character or an image or the like included in an application, screen data for displaying a screen, or the like. The customer terminal 100 receives the requested Web data and displays a display screen based on the received Web data, on a display.

In addition, when the application installed in the customer terminal 100 is used, credit card information has been registered in advance, so that the customer terminal 100 may make payments. The customer terminal 100 performs a payment process by running the application and scanning a scan code (for example, a QR code®).

The server 200 is connected to the customer terminal 100 and the retailer terminal 300 via the network. The server 200 includes a notification processing unit 210, a cryptocurrency imparting unit 220, a screen generation unit 230, an information updating unit 240, a retailer information storage unit 251, and a visit history information storage unit 252.

The image generation unit 230 of the server 200 generates a scan code for use in making payments on the basis of a retailer ID for identifying a retailer, number of people, and price. The image generation unit 230 also provides a scan code issuance screen including the scan code.

The information updating unit 240 of the server 200 obtains a customer ID when a payment is made, the customer ID being an application ID (an ID of the application itself assigned to a customer).

The information updating unit 240 also stores a customer ID for identifying a customer in the visit history information storage unit 252 in association with a retailer ID, visit date and time, price, and number of people obtained by the customer terminal 100 scanning the scan code.

The notification processing unit 210 of the server 200 refers to visit history information stored in the visit history information storage unit 252 and transmits a message or a coupon to a customer terminal 100 a visit of which has not been confirmed for a predetermined period of time or longer.

More specifically, the notification processing unit 210 obtains the visit history information from the visit history information storage unit 252 on a regular basis (every other day, for example), and transmits a message or a coupon to a customer terminal of a customer who has not visited a retailer for a predetermined period or longer. For example, the notification processing unit 210 of the server 200 transmits to the customer terminal 100 a message such as “YOU HAVEN'T VISITED US MORE THAN A MONTH”, or the like. On the basis of order information that makes up the visit history information, the notification processing unit 210 also transmits to the customer terminal 100 a coupon related to food and drink that has been ordered previously, or the like.

The customer terminal 100 displays the received message or coupon via the application.

This enables push notification via the application. It also makes it possible to automatically keep track of customers and increase a percentage of repeat customers who visit repeatedly.

More particularly, the notification processing unit 210 refers to the visit history. information stored in the visit history information storage unit 252, identifies a corresponding coupon on the basis of at least any one or more of the visit date and time (time zone), the price, the number of people, which make up the visit history information, and transits the identified coupon to the customer terminal 100. Then, it becomes possible to recommend, via the application, a recommended menu or a coupon on the basis of the time zone when the customer ate or drank as well as the price.

In addition, the notification processing unit 210 obtains information regarding a related shop from the retailer information storage unit 251, the related shop being a shop in another group when multiple shops are deployed. Then, the notification processing unit 210 estimates a customer's preference or a pattern of behavior on the basis of the time zone when the customer ate or drank, the price, or the like, and transmits a coupon of the related shop to the customer terminal 100. In a case where the multiple shops are deployed, in particular, this makes it possible to increase sales of the group as a whole, including the related shop.

The cryptocurrency imparting unit 220 of the server 200 calculates an amount of success fee, to be paid by the retailer to an operator of the server 200, by multiplying a food and drink charge, which is an amount to be paid by the customer, by a predetermined percentage (5% or higher, for example). Then, the notification processing unit 210 of the server 200 transmits to the retailer terminal 300 the amount of success fee that corresponds to the amount calculated by the cryptocurrency imparting unit 220.

The cryptocurrency imparting unit 220 of the server 200 calculates an amount of cryptocurrency to be given to the customer by multiplying the food and drink charge by a predetermined percentage (1% or higher, for example). Then, the notification processing unit 210 of the server 200 transmits to the customer terminal 100 the amount of cryptocurrency that corresponds to the amount calculated by the cryptocurrency imparting unit 220.

It is to be noted that the cryptocurrency imparting unit 220 may calculate the amount of cryptocurrency to be given to the customer by multiplying the amount of success fee by a predetermined percentage (10 to 40%, for example). More specifically, the cryptocurrency imparting unit 220 calculates a part of the amount of success fee as cryptocurrency.

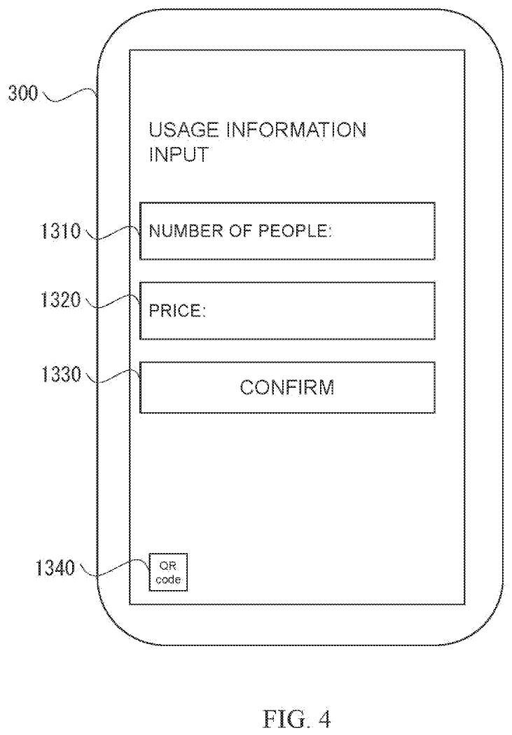

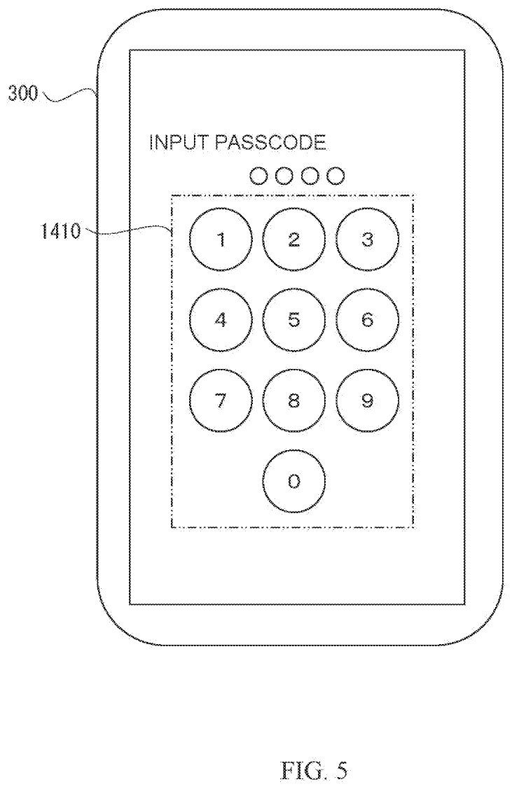

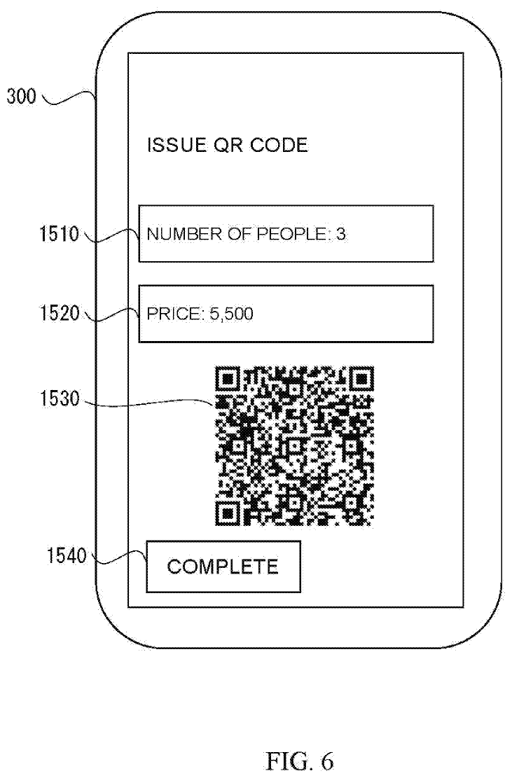

The retailer terminal 300 has an application for making settlements and accumulating the visit history information installed in advance, the application for displaying a usage information input screen (to be described below, FIG. 4), a passcode input screen (to be described below, FIG. 5), and the scan code issuance screen (to be described below, FIG. 6).

The retailer terminal 300 accumulates the visit history information by scanning a scan code and making settlements. Specifically, the retailer terminal 300 obtains a customer ID, visit date and time, and price by scanning the scan code. Then, the retailer terminal 300 calculates an amount of cryptocurrency by multiplying the obtained price by a predetermined percentage, The retailer terminal 300 stores the obtained customer ID in the visit history information storage unit 252 in association with the visit date and time, the price, and the amount of cryptocurrency.

### Retailer Information

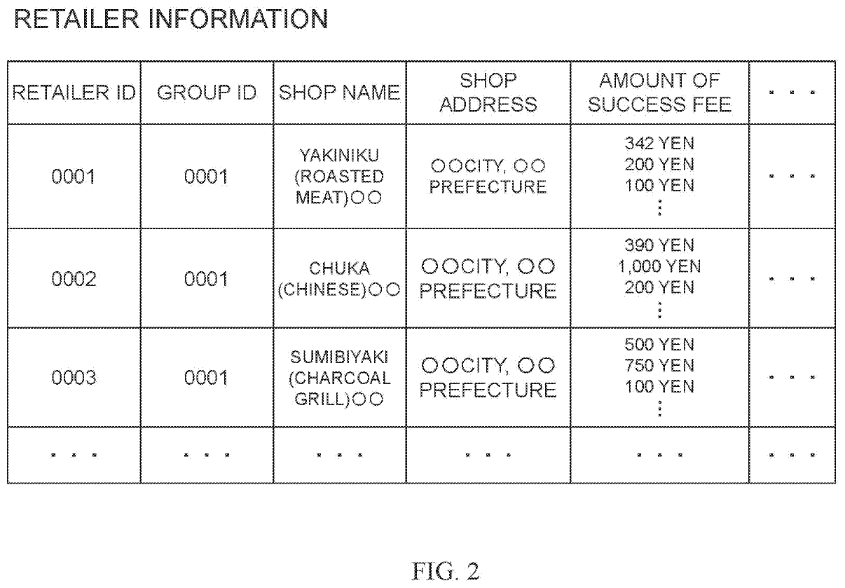

FIG. 2 is a diagram illustrating an overview of a configuration example of the retailer information stored in the retailer information storage unit in the first embodiment of the present invention. As illustrated in FIG. 2, the retailer information includes a retailer ID, a group ID, a shop name, a shop address, and an amount of success fee,

The retailer ID represents a code for identifying a shop. The group ID represents a code for identifying a group in a case where multiple shops are deployed. The shop name represents a name of a shop. The shop address represents an address of the shop. The amount of success fee represents an amount of success fee that the server operator charges to the retailer.

### Visit History Information

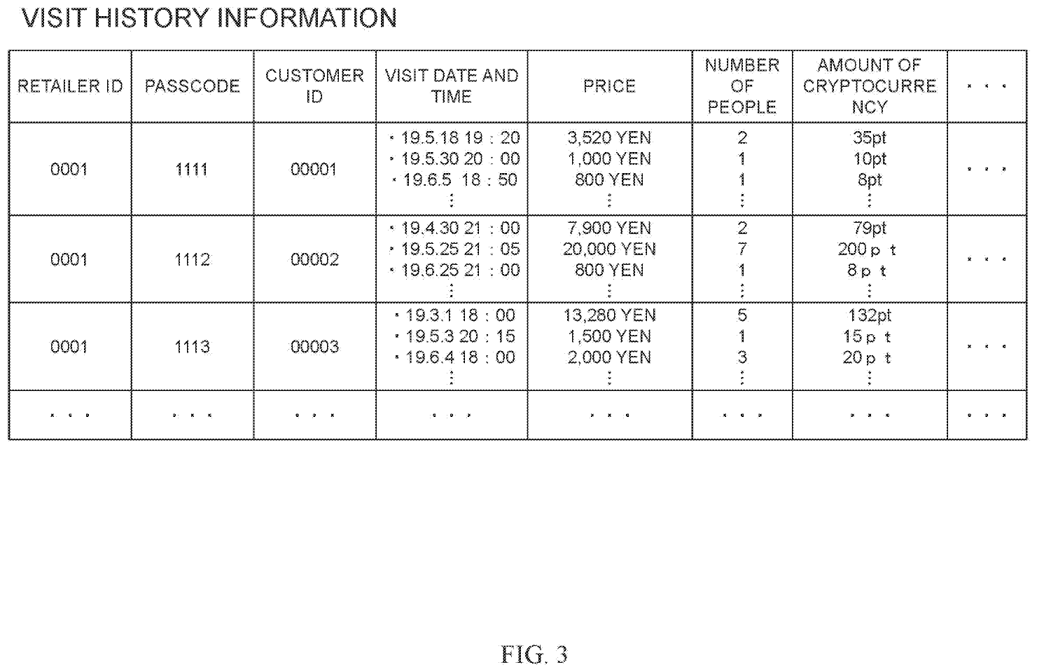

FIG. 3 is a diagram illustrating an overview of a configuration example of the visit history information stored in the visit history information storage unit of the server in the first embodiment of the present invention. As illustrated in FIG. 3, the visit history information includes a retailer ID, a passcode, a customer ID, visit date and time, price, number of people, and an amount of cryptocurrency.

The passcode is a code to be assigned in association with personal information such as an employee name or the like and is used to identify employees. The customer ID represents a code for identifying a customer. The visit date and time represents a date and time of a customer's visit. The price represents an amount paid by a customer. The number of people represents a number of customers who visited. The amount of cryptocurrency is an amount of cryptocurrency given to the customer.

### Usage Information Input Screen

FIG. 4 is a diagram illustrating an overview of a configuration example of the usage information input screen displayed on a display of the retailer terminal 300 in the first embodiment of the present invention. As illustrated in FIG. 4, on the usage information input screen are displayed a number of people input field 1310, a price input field 1320, a CONFIRM button 1330, and a START SCAN CODE SCANNING button 1340.

The number of people input area 1310 accepts input of number of customers who visited a shop. The price input field 1320 accepts the input of an amount of money that the customer spent at the shop.

When the CONFIRM button 1330 accepts input, the retailer terminal 300 transmits the number of people entered in the number of people input field 1310 and the price entered in the price input field 1320 to the server 200.

When the START SCAN CODE SCANNING button 1340 is selected, the retailer terminal 300 displays, on the display, the passcode input screen (to be described below, FIG. 5) provided by the server 200.

### Passcode Input Screen

FIG. 5 is a diagram illustrating an overview of a configuration example of the passcode input screen displayed on the display of the retailer terminal 300 in the first embodiment of the present invention. As illustrated in FIG. 5, a PASSCODE INPUT BUTTON 1410 is displayed on the passcode input screen. A passcode is entered by the PASSCODE INPUT BUTTON 1410 accepting the input. The retailer terminal 300 transmits, to the server 200, the entered passcode, and the number of people and the price entered via the usage information input screen.

When the passcode is entered, the retailer terminal 300 displays, on the display, the scan code issuance screen (to be described below, FIG. 6) provided by the server 200.

### Scan Code Issuance Screen

FIG. 6 is a diagram illustrating an overview of a configuration example of the scan code issuance screen displayed on the display of the retailer terminal 300 in the first embodiment of the present invention. As illustrated in FIG. 6, a number of people display field 1510, a price display field 1520, a scan code 1530, and a COMPLETE BUTTON 1540 are displayed on the scan code issuance screen.

The number of people entered on the usage information input screen is displayed in the number of people display field 1510. The price entered on the usage information input screen is displayed in the price display field 1520.

When the COMPLETE button 1540 accepts input after the customer terminal 100 scans the scan code 1530, the retailer terminal 300 transmits, to the server 200, a notification that the COMPLETE button 1540 has accepted the input. When the server 200 receives the notification that the COMPLETE button 1540 has accepted the input, the server 200 generates a confirmation screen (to be described below, FIG. 7) and provides the customer terminal 100 with the generated confirmation screen.

### Confirmation Screen

FIG. 7 is a diagram illustrating an overview of a configuration example of the confirmation screen displayed on a display of the customer terminal 100 in the first embodiment of the present invention.

As illustrated in FIG. 7, a price display field 1610, a REFUSE APPROVAL button 1620, and an APPROVE button 1630 are displayed on the confirmation screen. Price input of which is accepted by the price input field 1320 is displayed in the price display field 1610.

When the APPROVE button 1630 accepts input, the customer terminal 100 displays, on the display, the completion screen (to be described below, FIG. 8) provided by the server 200.

### Completion Screen

FIG. 8 is a diagram illustrating an overview of a configuration example of the completion screen displayed on the display of the customer terminal 100 in the first embodiment of the present invention.

As illustrated in FIG. 8, a COMPLETE button 1710 is displayed on the completion screen. In addition, on the completion screen, a message indicating when cryptocurrency will be given is displayed, such as “CRYPTOCURRENCY WILL BE GIVEN AT ACTUAL VALUE RATE WITHIN 15 DAYS” or the like.

When the COMPLETE button 1710 accepts the input, a series of processes from a settlement process to a cryptocurrency process is completed.

It is to be noted that when the completion screen may be displayed not only on the display of the customer terminal 100 but also on the display of the retailer terminal 300. In addition, the given amount of cryptocurrency may be displayed on the display of the customer terminal 100, and the amount of success fee may be displayed on the display of the retailer terminal 300.

### Overall Processing

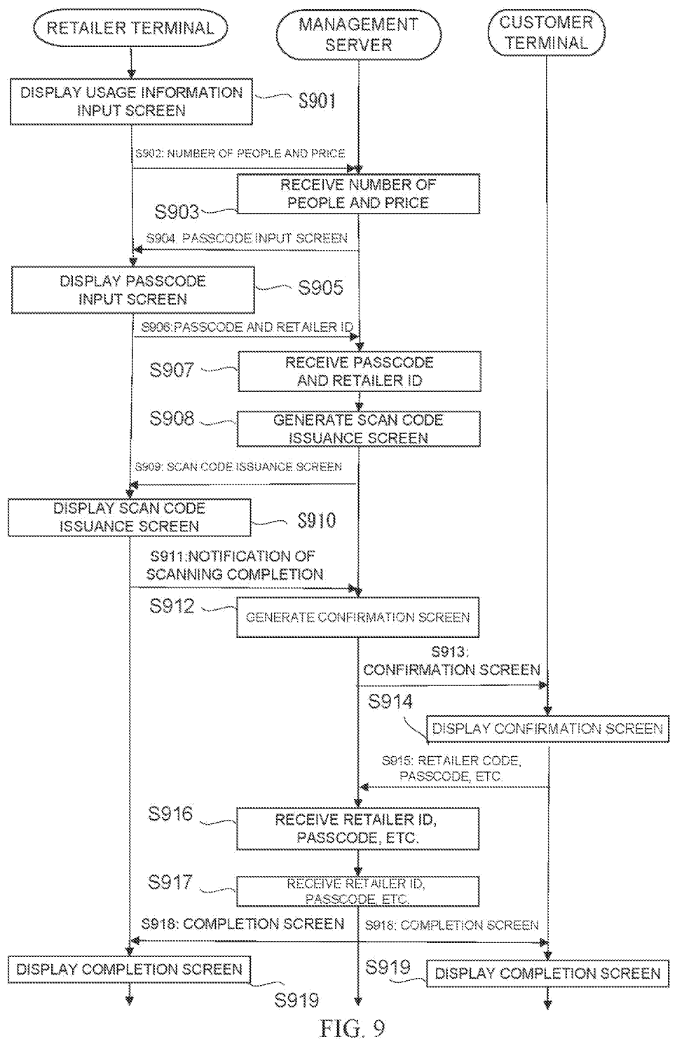

FIG. 9 is a diagram illustrating an overview of overall processing of the payment system in the first embodiment of the present invention.

First, in step S901, the display of the retailer terminal 300 displays the usage information input screen on the display. Then, the number of people input area 1310 of the usage information input screen displayed on the retailer terminal 300 accepts the input of the number of customers who visited. Furthermore, the price input field 1320 of the usage information input screen displayed on the retailer terminal 300 accepts the input of the amount of money spent by the customers. The usage information input screen is provided by the server 200. It is to be noted that the usage information input screen is provided by the screen generation unit 230 of the server 200.

When the CONFIRM button 1330 accepts the input, in S902, the retailer terminal 300 transmits, to the server 200, the number of people in the number of people input field 1310 and the price in the price input field 1320 which are entered in S901. Then, then, when the START SCAN CODE SCANNING button 1340 accepts the input (selection), the process proceeds to S903. It is to be noted that when the START SCAN CODE SCANNING button 1340 accepts the input in S902, the retailer terminal 300 may transmit, to the server 200, the number of people in the number of people input field 1310 and the price in the price input field 1320 which are entered in S901.

Next, in S903, the server 200 receives the number of people and the price that are transmitted in S902.

Next, in S904, the screen generation unit 230 of the server 200 provides the retailer terminal 300 with the passcode input screen (described above, FIG. 5).

Next, in S905, the display of the retailer terminal 300 displays the passcode input screen on the display. Input of the passcode is accepted via the passcode input screen. More particularly, the retailer terminal 300 displays the ENTER PASSCODE button 1410 on the passcode input screen, and the ENTER PASSCODE button 1410 accepts the input.

Next, in S906, the retailer terminal 300 transmits, to the server 200, the passcode input of which is accepted in S905 and the retailer ID.

Next, in S907, the server 200 receives the passcode and the retailer ID that are transmitted in S906.

Next, in S908, the screen generation unit 230 of the server 200 generates a scan code for use in making settlements on the basis of the retailer code, and the number of people and the price that are received in S903. The screen generation unit 230 also generates the scan code issuance screen (described above, FIG. 6) on the basis of the generated scan code, and the number of people and the price that are received in S903.

Next, in S909, the screen generation unit 230 of the server 200 provides the retailer terminal 300 with the scan code issuance screen that is generated in S908.

Next, in S910, the retailer terminal 300 displays the scan code issuance screen on the display. Then, after the customer terminal 100 scans the scan code 1530, the retailer terminal 300 accepts the input of the COMPLETE button 1540. When the COMPLETE button 1540 accepts the input, in S911, the retailer terminal 300 transmits, to the server 200, a notification that the COMPLETE button has accepted the input.

It is to be noted that after scanning the scan code, the retailer terminal 100 may transmit, to the server 200, the notification that the scanning is complete.

Next, in S912, upon receipt of the notification that the COMPLETE button 1540 has accepted the input, the screen generation unit 230 of the server 200 generates the confirmation screen (described above, FIG. 7).

Next, in S913, the screen generation unit 230 of the server 200 provides the customer terminal 100 with the generated confirmation screen.

Next, in S914, the customer terminal 100 displays the confirmation screen on the display. Then, the customer terminal 100 accepts input of a COMMODITY button 1630. More particularly, the customer terminal 100 displays the price display field 1610, the REFUSE APPROVAL button 1620, and the APPROVE button 1630 on the confirmation screen, and the ACCEPT button accepts the input. It is to be noted that after S914, information on whether or not to approve is transmitted to the server 200.

Next, in S915, the customer terminal 100 transmits, to the server 200, the retailer ID, the passcode, the visit date and time, the price, and the number of people that are obtained by the customer ID and the scan code 1530 being scanned.

It is to be noted that the retailer ID may be a user ID of an application installed in a mobile terminal 100, an ID of an application itself assigned to a customer, information for identifying a SIM (subscriber identity module) card inserted in the mobile terminal 100, or information for identifying the mobile terminal 100 itself. Furthermore, the customer ID may be acquired by scanning personal information of the customer from the scan code 1530.

Next, in S916, the server 200 receives the customer ID, the retailer ID, the passcode, the visit date and time, the price, and the number of people that are transmitted in S915. Then, the cryptocurrency imparting unit 220 of the server 200 calculates an amount of success fee to be charged to the retailer by multiplying the received price (food and drink charge) by a predetermined percentage (5% or higher, for example). The cryptocurrency imparting unit 220 also calculates the amount of cryptocurrency to be given to the customer by multiplying the price (food and drink charge) by a predetermined percentage (1% or higher, for example).

Next, in S917, the server 200 associates the retailer ID, the passcode, the customer ID, the visit data and time, the price, and the number of people, which are received in S916, with the amount of cryptocurrency, which is calculated in S916, and stores them in the visit history information storage unit 252.

Next, in S918, the screen generation unit 230 of the server provides the customer terminal 100 and the retailer terminal 300 with the completion screen (described above, FIG. 8). The notification processing unit 210 of the server 200 transmits the calculated amount of cryptocurrency to the customer terminal 100. The notification processing unit 210 of the server 200 also transmits the calculated amount of success fee to the retailer terminal 300.

Next, in S919, the customer terminal 100 and the retailer terminal 300 each displays the completion screen on the display. A COMPLETE button 1710 is displayed on the completion screen. When the COMPLETE button 1710 accepts the input, a series of processes from the settlement process to the cryptocurrency processing is completed.

It is noted that in S907, the server 200 may associate the received passcode and the retailer ID with the number of people and the price, which are received in S903, and store them in the visit history information storage unit 252.

in addition, not only the completion screen is displayed on the display of the customer terminal 100, but also, in S915, the customer terminal 100 may transmit, to the retailer terminal 300, a notification that the APPROVE button 1630 has accepted the input.

Alternatively, processes in S905 to S908 may be performed simultaneously with those of S901 to S903. That is, after the usage information input screen is displayed where the input of the number of people and the price is accepted, the passcode input screen may be displayed where the input of the passcode and the retailer ID is accepted. In that case, the retailer terminal 300 transmits, to the server 200, the number of people, the price, the passcode, and the retailer all together.

In addition, the processes of S915 to S917 may be performed simultaneously with the process of S911. That is, the processes of S916 and S917 may be performed by transmitting the retailer ID, the passcode, the visit date and time, the price, and the number of people, together with the notification that the scanning is complete.

In addition, the processes of S905 to S907 described above may be omitted.

Furthermore, for a shop that has no smart phone or tablet, or the like, the server 200 may be configured to make settlements by causing the customer terminal 100 to scan a QR code printed on a paper and placed in the shop.

### Effects of First Embodiment

According to the first embodiment described above, the screen generation unit 230 generates the scan code 1530 for making payments on the basis of the retailer ID, the number of people, and the price, and provides the scan code issuance screen including the scan code 1530. The information updating unit 240 stores, in the visit history information storage unit 252, the customer ID in association with the retailer ID, the visit date and time, the price, and the number of people that are obtained by the customer terminal 100 scanning the scan code 1530. This facilitates payments and enables the customer relationship management.

In addition, the notification processing unit 210 may refer to the visit history information stored in the visit history information storage unit 252 and transmit a message and/or coupon to the customer terminal 100 of the customer who has not visited for a predetermined period of time or longer, thereby encouraging the customer to visit from the next time onward.

In addition, the notification processing unit 210 refers to the visit history information stored in the visit history information storage unit 252, identifies the corresponding coupon on the basis of at least any one or more of the visit date and time, the price, or the number of people, which make up the visit history information, and transmits the identified coupon to the customer terminal 100. This makes it possible to encourage, with a higher precision, the customer to visit from the next tune onward, while considering the pattern of customer's behavior.

In addition, the cryptocurrency amount calculation unit 220 calculates the amount of cryptocurrency to be given to the customer by multiplying the price by the predetermined percentage, and the notification processing unit 210 transmits the amount of cryptocurrency to the customer terminal 100. This makes it possible to give incentives in accordance with a customer's visit record.

Furthermore, the cryptocurrency amount calculation unit 220 calculates the amount of success fee to be paid by the retailer to the operator of the server 200, by multiplying the price by the predetermined percentage, and calculates the amount of cryptocurrency to be given to the customer, by multiplying the amount of success fee by the predetermined percentage. The notification processing unit 210 transmits the amount of success fee to the retailer terminal 300 and transmits the amount of cryptocurrency to the customer terminal 300. This makes it possible to give a part of the success fee, which is paid to the operator of the server, to the customer as an incentive, in accordance with the customer's visit record.

### Second Embodiment

### Overall Configuration

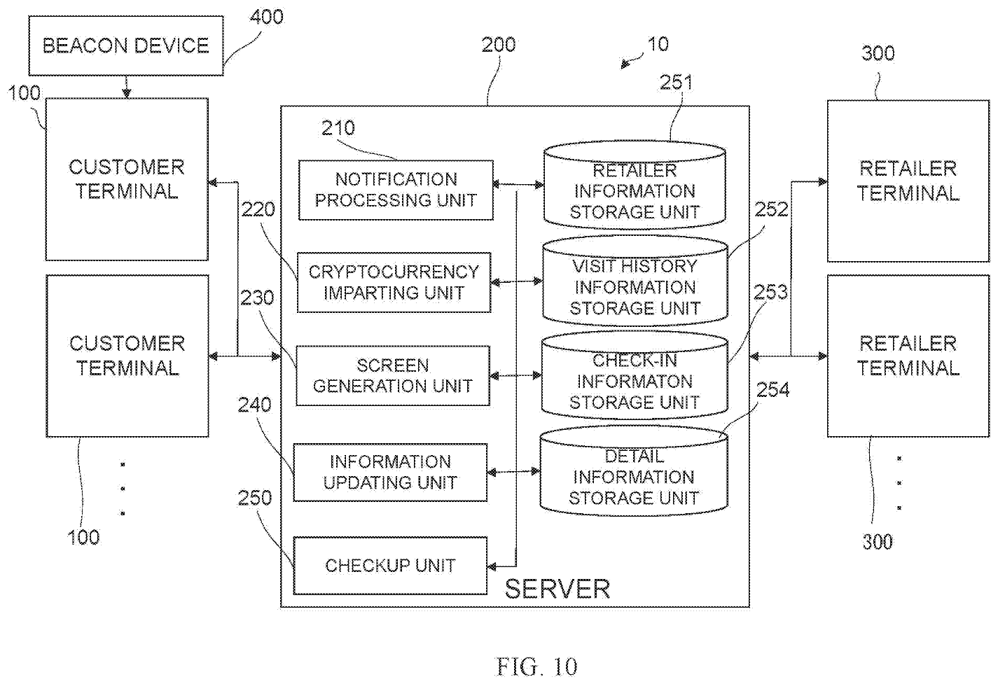

FIG. 10 is a diagram illustrating an overview of an overall configuration example of a payment system in a second embodiment of the present invention, As illustrated in FIG. 10, a payment system 10 includes the customer terminal 100, the server 200 connected to the customer terminal 100 via the network, the retailer terminal 300 connected to the server 200 via the network, and the customer terminal 100 to which data is transmitted from a beacon device 400 via wireless communications.

The server 200 includes the retailer information storage unit 252, the visit history information storage unit 252, a check-in information storage unit 253, and a detail information storage unit 254.

The beacon device 400 is installed in a shop or the like. Utilizing short-range wireless (Bluetooth®, or the like), the beacon device 400 transmits, to the customer terminal 100, beacon device identification information for identifying the beacon device 400. As a result, the beacon device 400 transmits the beacon device identification information to the customer terminal 100 in the shop.

It is to be noted that the beacon device 400 may transmit current date and time together with the beacon device identification information.

In addition, utilizing ultrawideband wireless communications (Ultra Wide Band), the beacon device 400 may transmit the beacon device identification information for identifying the beacon device 400 to the customer terminal 100. Alternatively, in a case where the customer terminal 100 receives radio waves from the beacon devices 400 installed in a plurality of locations, radio field intensity patterns unique to the locations may be utilized as identification information.

The customer terminal 100 receives the beacon device identification information transmitted from the beacon device 400 via the wireless communications,

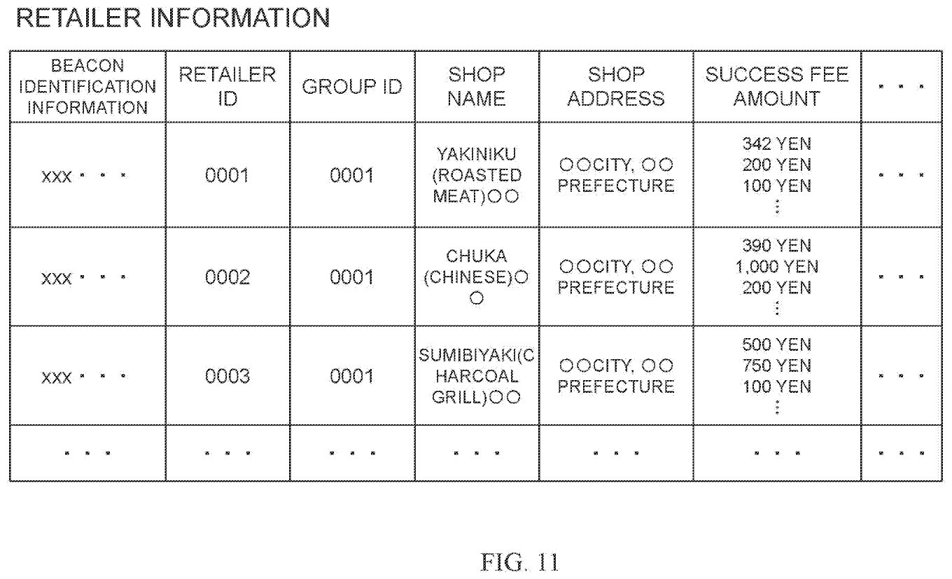

As illustrated in FIG. 11, the retailer information storage unit 251 in the second embodiment stores retailer information to which the beacon device identification information is added, the beacon device identification information representing a code for identifying the beacon device 400. Then, the notification processing unit 210 of the server 200 obtains from the retailer information storage unit the retailer information that corresponds to the beacon device identification information transmitted by the beacon device 400 to the customer terminal 100.

it is to be noted that the retailer information storage unit 251 may include latitude and longitude information for identifying a shop position.

In addition, after the customer terminal 100 receives the beacon device identification information from the beacon device 400, check-in may be recorded, by a popup display appearing on a display and input from clicking on a displayed target being accepted. This allows check-in with the beacon device 400 to be a prerequisite for using a credit card.

### Check-In Information

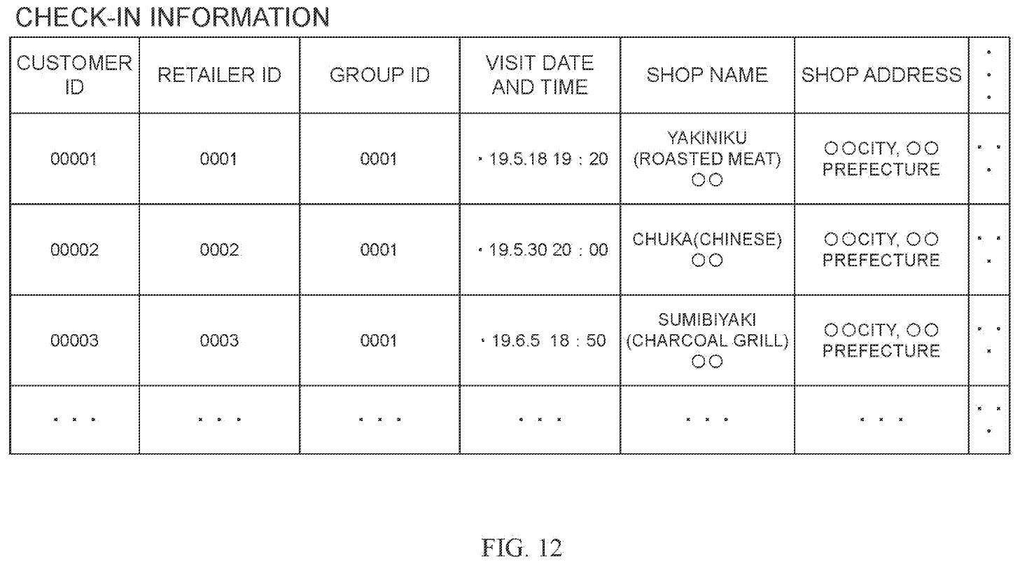

FIG. 12 is a diagram illustrating an overview of a configuration information of the check-in information stored in the check-in information storage unit in the second. embodiment of the present invention. As illustrated in FIG. 12, the check-in information includes the customer ID, the retailer ID, the group ID, the visit date and time, the shop name, and a visited shop address. The visit date and time represents the date and time of a customer's visit.

### Detail Information

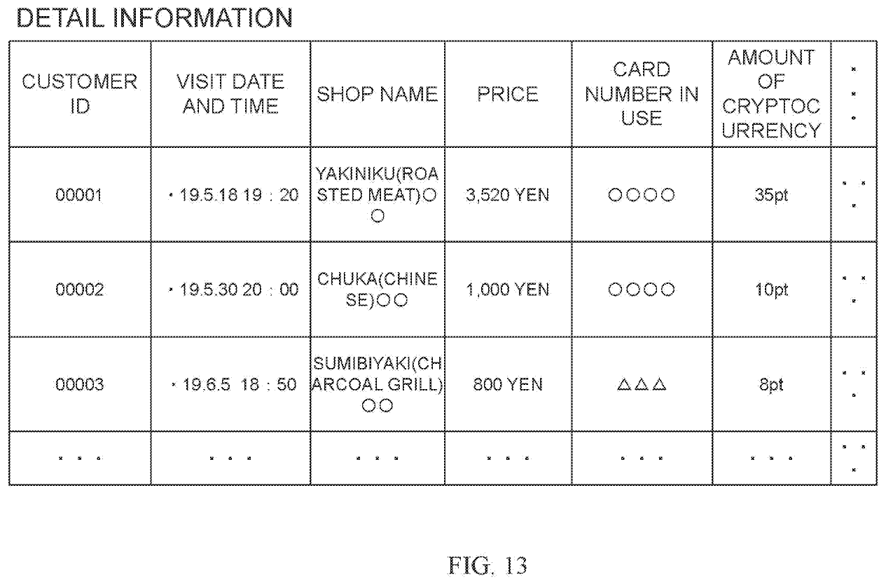

FIG. 13 is a diagram illustrating an overview of a configuration example of detail information stored in the detail information storage unit of the server in the second embodiment of the present invention. As illustrated in FIG. 13, the detail information includes the customer ID, the visit date and time, the shop name, the price, card number in use, and the amount of cryptocurrency.

The card number in use represents a number of a card used by the customer.

### Payment Information

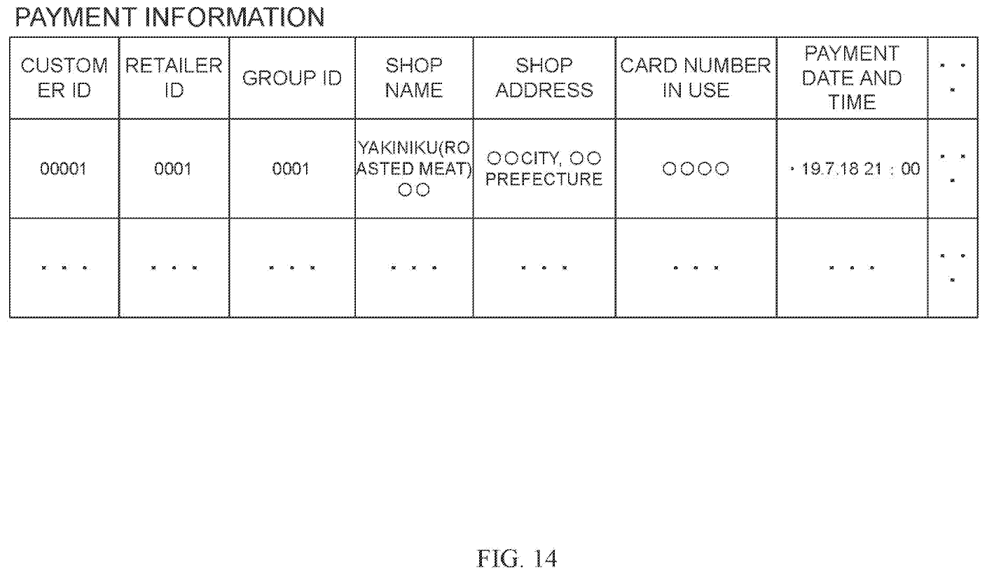

FIG. 14 is a diagram illustrating an overview of a configuration example of payment information stored in a payment information storage unit of the server in the second embodiment of the present invention. As illustrated in FIG. 14, the payment information includes the customer ID, the retailer ID, the group ID, the shop name, the shop address, the card in use, and payment date and time. The payment date and time represents date and time when a payment is made.

### Card Information Input Screen

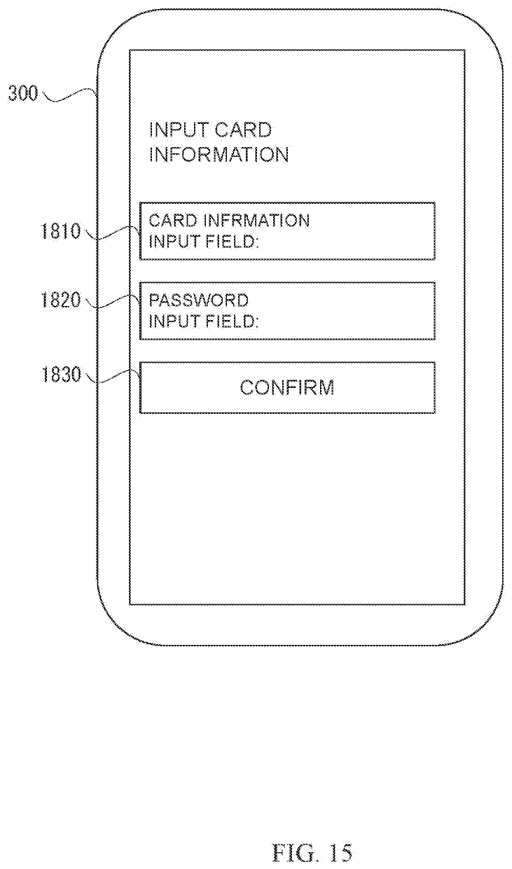

FIG. 15 is a diagram illustrating an overview of a configuration example of a card information input screen displayed on the display of the customer terminal 100 in the second embodiment of the present invention. As illustrated in FIG. 14, on the card information input screen are displayed a card number input field 1810, a password input field 1820, and a CONFIRM button 1830.

The card number input field 1810 accepts input of a card number of a customer who visits. The password input field 1820 accepts input of a password of a card that a customer has set and registered in advance.

When the CONFIRM button 1830 accepts the input, the customer terminal 100 transmits, to the server 200, the number entered in the card number input field 810 and the password entered in the password input field 1820.

In a case where the password tied to the card number is correct, the customer terminal 100 proceeds to a logged-in state. The customer terminal 100 also extracts the customer ID from the received card information and calls the detail information from the detail information storage unit.

The cryptocurrency imparting unit 220 of the server 200 identifies a visit to a member shop from the detail information. Then, the cryptocurrency imparting unit 220 calculates an amount of success fee charged to the retailer by multiplying the price (food and drink charge) included in the detail information by a predetermined percentage (5% or higher, for example). The cryptocurrency imparting unit 220 also calculates an amount of cryptocurrency to be given to the customer by multiplying the price (food and drink charge) by a predetermined percentage (1% or higher, for example).

It is to be noted that the cryptocurrency imparting unit 220 of the server 200 may identify a visit to any shop other than the member shop, by referring to the detail information and obtaining a name of a shop other than the member shop. In that case, similarly, the cryptocurrency imparting unit 220 does not calculate the amount of success fee to be charged to the retailer. On the other hand, the cryptocurrency imparting unit 220 calculates the amount of cryptocurrency to be given to the customer by multiplying the price (food and drink charge) by a predetermined percentage (1% or higher, for example).

This allows users to earn both points to be obtained by use of the credit card and cryptocurrency at many more retailers. Furthermore, this allows operators of servers to find member shops without incurring operating costs, although the operators are not able to earn any success fee. Then, the operators are able to implement measures targeted for many more retailers and users. Then, the operators are able to increase the success fee and amount of outflow of cryptocurrency.

Furthermore, it becomes possible for the operator of the server 200 to accumulate big data on users' consumer activities. In addition, before visiting a member shop for sales, the operator is able to clarify in advance an actually recorded number of customers they could send to that shop and customers targeted for management of customer relationships.

In addition, the operator of the server 200 is able to expect an increase in the value of cryptocurrency by repurchasing from the trading market the cryptocurrency they spent as returns to the customer.

It is to be noted that “card information” used in the present invention may refer to login information of a WEB service that allows for viewing of usage history provided by an issuer, and not a credit card number.

### Overall Processing

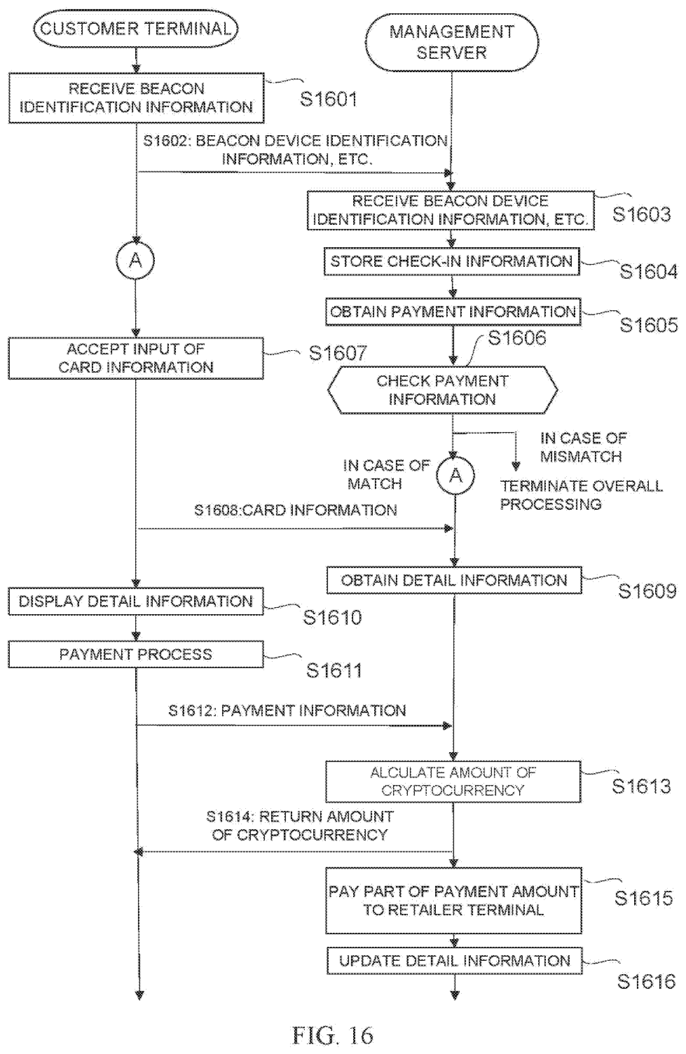

FIG. 16 is a diagram illustrating an overview of overall processing of the payment system in the second embodiment of the present invention.

First, in S1601, the customer terminal 100 receives the beacon device identification information that is transmitted from the beacon device 400 on a regular basis.

Next, in S1602, the customer terminal 100 transmits, to the server 200, the beacon device identification information transmitted from the beacon device 400 to the customer terminal 100 in S1601, the customer ID, and visit time, which is the current time.

Next, in S1603, the server 200 receives the beacon device identification information, the customer ID, and the visit time that are transmitted in S1602. Then, the information updating unit 240 of the server 200 searches the retailer information storage unit 251 with the received beacon identification information as a key and obtains corresponding retailer information.

Next, in S1604, the information updating unit 240 of the server 200 stores the check-in information in the check-in information storage unit 253, wherein the check-in information associates the customer ID and the visit time, which are received in S1603, with the retailer information acquired in S1603, the retailer information being made up of the retailer ID, the group ID, the shop name, and the shop address.

Next, in S1605, a checkup unit 250 searches the payment information storage unit with the customer ID received in S1603 as a key, and obtains corresponding payment information.

Next, in S1606, the checkup unit 250 checks the check-in information stored in S1604 against the payment information obtained in S1605. More particularly, the checkup unit 250 checks whether or not the customer ID, the retailer ID, the group ID, the shop name, and the shop address, which make up the check-in information, match the customer ID, the retailer ID, the group ID, the shop name, and the shop address, which make up the payment information. It is to be noted that checkup unit 250 may check whether or not the customer ID, the retailer ID, the group ID, the shop name, and the shop address, which make up the check-in information, partly match the customer ID, the retailer ID, the group ID, the shop name, and the shop address, which make up the payment information. This makes it possible to check a shop where a payment is actually made against a shop identified by the information from the beacon device 400, thus allowing for improved accuracy of payments.

Then, in S1606, if the checkup unit 250 judges that the check-in information and the payment information do not match, the screen generation unit 230 of the server 200 outputs an error message such as “PAYMENT NOT POSSIBLE” and terminates the overall processing. On the other hand, in S1606, if the checkup unit 250 judges that the check-in information and the payment information match, the process proceeds to S1607.

Next, in S1607, the customer terminal 100 accepts input of predetermined items on the card information input screen appearing on the display and logs in.

Next, in S1608, the customer terminal 100 transmits, to the server 200, the card information input of which is accepted on the card information input screen when the customer terminal 100 logs in in S1607.

Next, in S1609, the server 200 obtains the detail information tied to the corresponding customer ID from the detail information storage unit 254, on the basis of the card information received from the customer terminal 100.

Next, in S1610, the customer terminal 100 displays the detail information on the screen after the customer terminal 100 logs in in S1607.

Thereafter, in S1611, the customer terminal 100 performs a payment process by causing the customer to use the credit card linked with the detail information.

Next, in S1612, the customer terminal 100 transmits, to the server 200, the information on the payment process that the customer terminal 100 performed in S1611.

Next, in S1613, the server 200 calculates the amount of cryptocurrency on the basis of the payment information received from the customer terminal 100 in S1612.

Next, in S1614, the server 200 returns to the customer terminal 100 a part of the amount of cryptocurrency calculated in S1613.

Next, in S1615, the server 200 pays to the retailer terminal 300 a part of the payment amount that is calculated on the basis of the payment information received from the customer terminal 100 in S1612.

Thereafter, in S1616, the server 200 overwrites the detail information that is called from the detail information storage unit 254 in S1609 with the payment information received from the customer terminal 100 in S1612, and performs update registration.

### Effects of Second Embodiment

According to the second embodiment described above, the checkup unit 250 checks the check-in information that includes the customer ID and the retailer information identified from the beacon device identification information against the payment information stored in advance. This makes it possible to check the shop where the payment is made against the information from the beacon device 400, thus allowing for the improved accuracy of payments.

In addition, it is possible to realize the check-in function via the beacon device 400 as a prerequisite for the use of the credit card, thus making it possible to enhance security involved in payments with the credit card. Furthermore, the server 200 is able to recognize the customer and the retailer immediately after the customer terminal 100 receives the beacon identification information from the beacon device 400. This allows for payments with the security maintained from the time of check-in (immediately after check-in).

### Third Embodiment

### Overall Processing

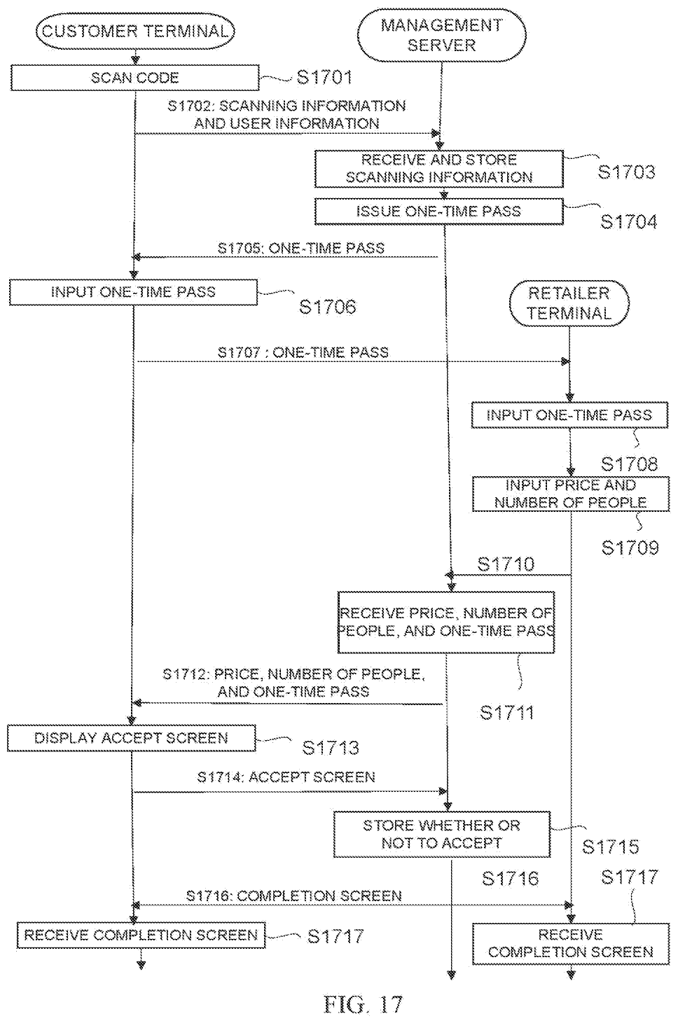

FIG. 17 is a diagram illustrating an overview of overall processing of a payment system in a third embodiment of the present invention.

First, in S1701, the customer terminal 100 scans a QR code.

Next, in S1702, the customer terminal 100 transmits, to the server 200, scanning information that corresponds to the QR code scanned by the customer terminal 100 in S1701.

Next, in S1703, the server 200 receives the scanning information transmitted in S1702 and stores the scanning information in the check-in information storage unit 253. Then, the information updating unit 240 of the server 200 searches the retailer information storage unit 251 with the received scanning information as a key, and obtains corresponding retailer information.

Next, in S1704, the information updating unit 240 of the server 200 issues one-time pass.

Next, in S1705, the server 200 transmits the one-time pass issued in S1704 to the customer terminal 100.

Next, in S1706, the customer terminal 100 displays, on the display, the one-time pass transmitted from the server 200 in S1705.

Next, in S1707, the customer terminal 100 transmits, to the server 200, the one-time pass displayed in the customer terminal 100 in S1706.

Next, in S1708, the retailer terminal 300 receives the one-time pass transmitted from the customer terminal 100 in S1707 and accepts input.

Next, in S1709, the retailer terminal 300 accepts input of price and number of people.

Thereafter, in S1710, the retailer terminal 300 transmits, to the server 200, the price and the number of people the input of which is accepted in S1709.

Next, in S1711, the server 200 receives the price, the number of people, and the one-time pass transmitted from the retailer terminal 300 in S1710.

Next, in S1712, the server 200 transmits the price, the number of people, and the one-time pass, which are received in S1711, to the customer terminal 100.

Next, in S1713, when receiving the price, the number of people, and the one-time pass which are transmitted from the server 200 in S1712, the customer terminal 100 displays an acceptance screen on the display.

Next, in S1714, the customer terminal 100 transmits, to the server 200, the acceptance screen displayed on the display of the customer terminal 100 in S1713.

Next, in S1715, the server 200 receives the acceptance screen transmitted from the customer terminal 100 in S1714 and stores whether or not to accept, in the check-in information storage unit 253.

Next, in S1716, the server 200 transmits the completion screen to the customer terminal 100 and the retailer terminal 300.

Thereafter, in S1717, the customer terminal 100 and the retailer terminal 300 receive the completion screen transmitted in S1716 and display the completion screen on the display.

### Effects of Third Embodiment

According to the third embodiment described above, the check-in information that includes the customer information and the retailer information identified by scanning of the QR code against the payment information stored in advance. This makes it possible to check the shop where the payment is made against the customer information, thus allowing for the improved accuracy of payments.

Furthermore, for a shop that has no smart phone or tablet, or the like, the server 200 is able to make settlements by causing the customer terminal 100 to scan the QR code printed on a paper and placed in the shop.

### Fourth Embodiment

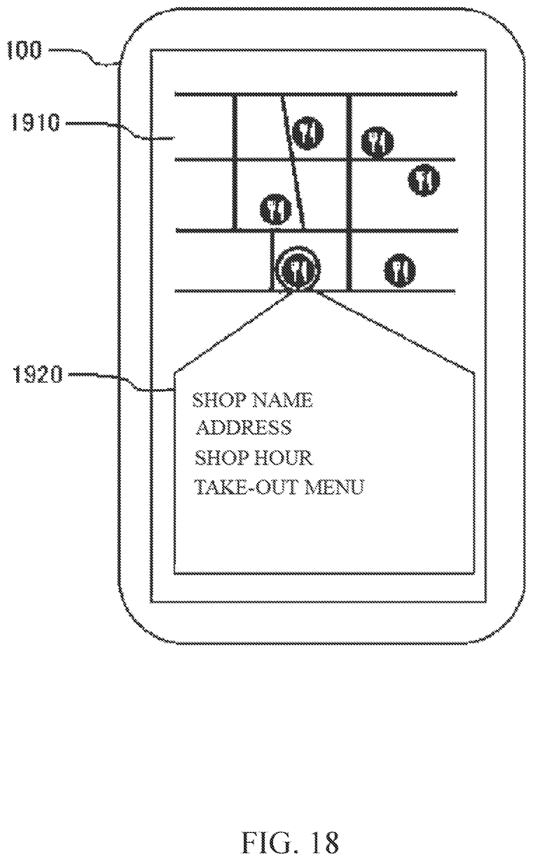

A description is given of overall processing of a payment system in a fourth embodiment of the present invention, on the basis of FIG. 9 described above. Here, in the fourth embodiment of the present invention, a case is assumed where a customer who visits a shop takes out food and drink. In this case, the notification processing unit 210 of the server 200 refers to the visit history information stored in the visit history information storage unit 252 and the retailer information stored in the retailer information storage unit 251, and transmits to the customer terminal 100 take-out information regarding food and drinks of shops that the customer has previously visited and of related shops thereof This is described on the basis of FIG. 18.

FIG. 18 is a diagram illustrating an overview of food and drink take-out information of shops displayed on the display of the customer terminal 100 in the fourth embodiment of the present invention. As illustrated in FIG. 18, on the display of the customer terminal 100, shops around a customer's current position where take-out of food and drink is possible appear in a map 1910. Here, the server 200 obtains the current position of the terminal transmitted from the customer terminal 100. Then, the server 200 transmits, to the customer terminal 100, information on the shops around the customer's current position where take-out of food and drink is possible, on the basis of the obtained current position of the customer terminal 100, the visit history information stored in the visit history information storage unit 252, and the retailer information stored in the retailer information storage unit 251. Thereby, the above-mentioned information is displayed on the display of the customer terminal 100. It is to be noted that the customer terminal 100 is provided with positional information acquisition means for obtaining the current position of the terminal. This positional information acquisition means is typically a GPS (Global Positioning System) device that receives GPS satellite signals and obtains positional information. The positional information obtained from the GPS device represents latitude, longitude, and altitude. The positional information acquisition means may be any positioning device based on GNSS (Global Navigation Satellite System) other than GPS or a positioning device based on positioning of a base station, as far as the device is able to obtain the current position of the customer terminal 100.

It is to be noted that the map 1910 displayed on the display of the customer terminal 100 may be a map of a predetermined area specified by the customer, and not the map around the customer's current position.

In addition, the server 200 may refer to the visit history information stored in the visit history information storage unit 252, and transmit, to the customer terminal 100 of the customer who wishes to have the food and drink take-out information, the food and drink take-out information of a shop that is posted in a social networking service (hereinafter referred to as SNS: Social Networking Service) by a customer who is different from the customer who wishes to have the food and drink take-out information and that has received more than a predetermined number of impressions (500,000 or more impressions, for example).

In this case, the customer terminal 100 has an application for using the SNS installed, which enables posting of a review of a shop, or the like. Then, the above-mentioned application is configured to be switchable between a posting function for an eat-in and a posting function for take-out.

Then, according to FIG. 18, on the display of the customer terminal 100 is displayed detailed retailer information 1920 including a take-out menu of food and drink of a selected shop, or the like. On the basis of such information, the customer is able to decide on a shop to take out, and actually visit the shop. Then, when the customer visits the shop, the overall processing of the payment system illustrated in FIG. 9 above is performed.

Here, in the present embodiment, the notification processing unit 210 of the server may refer to the visit history information regarding visits for take-out stored in the visit history information storage unit 252 and transmit a message and/or a coupon to the customer terminal 100 of the customer who visited to take-out, thereby encouraging the customer to visit for eat-in from next time onward. The notification processing unit 210 may also transmit a message and/or a coupon to any customer terminals of customers who have shown an interest in the shops illustrated in FIG. 18 as well as to the customer terminal 100 of the customer who actually visited to take-out. Note that it is possible to determine whether or not a customer has shown an interest in a shop, by means of a well-known approach, such as an analysis of selections of the customers from a list of the shops displayed on the map 1910, or the like.

The processing described above may also be applied to a case where a customer is served food and drink by delivery. In this case, the notification processing unit 210 of the server 200 transmits, to the customer terminal 100, food and drink delivery information of a shop which the customer has previously visited or a related shop thereof or of shops posted on the SNS. Then, on the basis of the information displayed on the display of the customer terminal 100, the customer may decide on a shop and be served food and drink from the shop by delivery. In this case, a terminal owned by a delivery person may be made the retailer terminal 300, and the overall processing of the payment system illustrated in FIG. 9 above may be performed between that retailer terminal 300 and the server 200.

Then, if the customer is served the food and drink by delivery, the notification processing unit 210 of the server 200 also refers to the visit history information regarding the use of delivery service that is stored in the visit history information storage unit 252, and transmits a message and/or a coupon to the customer terminals 100 of the customers who used the delivery service, which thereby makes it possible to encourage the customers to visit for eat-in from the next time onward.

### Effects of Fourth Embodiment

According to the fourth embodiment described above, the notification processing unit 210 refers to the visit history information stored in the visit history information storage unit 252 and transmits a message and/or a coupon to the customer terminals 100 of the customers who visited to take-out or used the delivery service, which thereby makes it possible to encourage the customers to visit from the next time onward.

As such, according to the fourth embodiment, it is possible to enable good customer relationship management.

### Fifth Embodiment

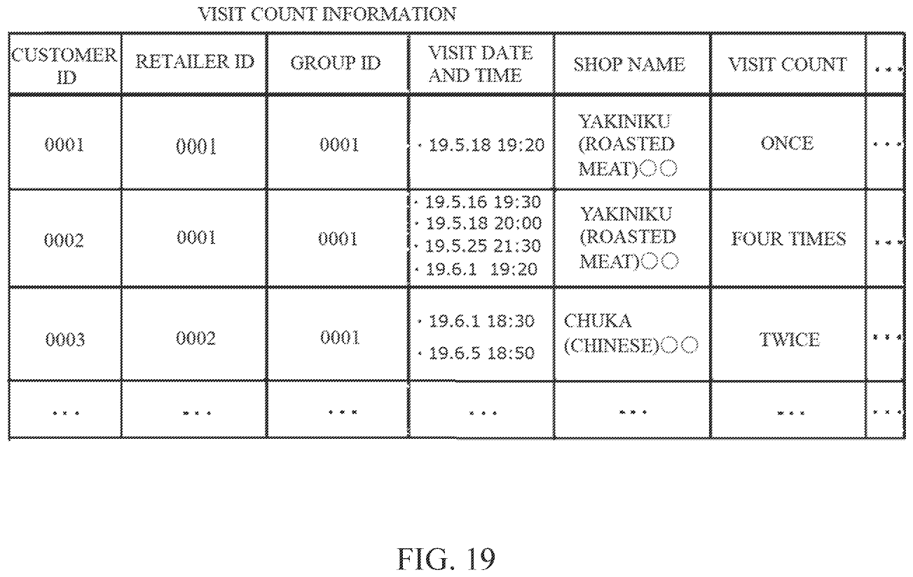

In the following, a description is given of a fifth embodiment of the present invention. In the present embodiment, preferential treatment is applied to a customer in accordance of a count of customer's visits to a shop. More particularly, the notification processing unit 210 of the server 200 refers to the visit history information stored in the visit history information storage unit 252 and transmits preferential treatment for the customer to the customer terminal 100. Here, the visit history information storage unit 252 stores visit count information based on visit date and time. FIG. 19 is a diagram illustrating an overview of a configuration example of the visit count information based on the visit date and time stored in the visit history information storage unit of the server in the fifth embodiment of the present invention. As illustrated in FIG. 19, the visit count information includes the customer ID, the retailer ID, the group ID, the visit date and time, the shop name, and a visit count.

Then, in the present embodiment, stage of member status of a customer is determined in accordance with the visit count, for example, which allows the customer to receive preferential treatment in accordance with each stage. It is to be noted that in order to encourage participation in such a preferential member program, for example, a screen for selecting participation in the program may be displayed on the display of the retailer terminal 300 together with the scan code, in the overall processing of the payment system illustrated in FIG. 9 above. Alternatively, by another means, a customer who has already been a shop member may automatically participate in the program. It is to be noted that visits to a shop may be counted for an eat-in visit or a take-out visit

In addition, a result of posting to the SNS may be taken into consideration in determining the stage of the customer's member status. For example, the stage of the customer's member status may be determined in accordance with the count of visits to the shop by the customer and the number of impressions posted on the SNS by the customer for the shop.

Then, the notification processing unit 210 of the server 200 refers to the visit count information based on the visit date and time stored in the visit history information storage unit 252 and transmits to the customer terminal 100 a message and/or a coupon in accordance with the stage of the customer's member status, which thereby makes it possible to encourage the customer to visit from the next time onward.

### Effects of Fifth Embodiment

According to the fifth embodiment described above, it is possible to enable good customer relationship management.

Although the present inventions made by the inventor have been described specifically on the basis of the embodiments, it is needless to say that the present inventions shall not be limited to the above-mentioned embodiments and that various changes may be made thereto without departing from the gist thereof

For example, the customer terminal 100 and the retailer terminal 300 shall include various forms of mobile devices such as a smart phone or the like, and all other PC terminals, in addition to tablet terminals.

In addition, the above-mentioned embodiments are described in detail to explain the present inventions in an easy-to-understand manner and shall not be necessarily limited to those having all of the described configurations. Furthermore, it is possible to replace a part of a configuration of one embodiment with a configuration of another embodiment or to add the configuration of the other embodiment to the configuration of the one embodiment. Moreover, other configuration may be added to, deleted from, or replaced with a part of a configuration of each embodiment.

In addition, each of the above-mentioned configurations, functions, and processing units may be realized, in part or as a whole, by hardware (integrated circuit, for example). Furthermore, each of the above-mentioned configurations, functions, and processing units may be realized by a processor interpreting and running a program that realizes each of the functions. It is possible to place information of the program that realizes each of the functions, a table, a file, or the like in a storage device such as a memory, a hard disk, an SSD (Solid State Drive) or the like, or in a recording medium such as an IC card, an SD card, a DVD, or the like.

### DESCRIPTION OF THE REFERENCE NUMERALS

100 Customer terminal
200 Server
300 Retailer terminal
400 Beacon device

1. A server that is connected to a customer terminal and a retailer terminal via a network, the server comprising:
a screen generation unit that generates a scan code for use in making a payment on the basis of a retailer ID, number of people, and price, and provides a scan code issuance screen including the scan code; and
an information updating unit that stores a customer ID in a visit history information storage unit in association with the retailer ID, visit date and time, the price, and the number of people obtained by the customer terminal scanning the scan code.

2. The server according to claim 1, further comprising:
a notification processing unit that refers to the visit history information stored in the visit history information storage unit and transmits a message and/or a coupon to the customer terminal of a customer who has not visited for a predetermined period of time or longer.

3. The server according to claim 1, further comprising:
a notification processing unit that refers to the visit history information stored in the visit history information storage unit, identifies a corresponding coupon on the basis of at least any one or more of the visit date and time, the price, and the number of people that make up the visit history information, and transmits the identified coupon to the customer terminal.

4. The server according to claim 1, further comprising:
a cryptocurrency amount calculation unit that calculates an amount of cryptocurrency to be given to the customer by multiplying the price by a predetermined percentage; and
a notification processing unit that transmits the amount of cryptocurrency to the customer terminal.

5. The server according to claim 1, further comprising:
a cryptocurrency amount calculation unit that calculates an amount of success fee to be paid by a retailer to an operator of the server by multiplying the price by a predetermined percentage and calculates the amount of cryptocurrency to be given to the customer by multiplying the amount of success fee by a predetermined percentage; and
a notification processing unit that transmits the amount of success fee to the retailer terminal and transmits the amount of cryptocurrency to the customer terminal.

6. The server according to claim 1, further comprising:
a checkup unit, that checks check-in information that includes the customer ID and retailer information identified from beacon device identification information against payment information stored in advance.

7. A payment method in a server that is connected to a customer terminal and a retailer terminal via a network, the payment method comprising:
a screen generation step of a screen generation unit generating a scan code for use in making a payment On the basis of a retailer ID, number of people, and price and providing a scan code issuance screen including the scan code; and
an information updating step of an information updating unit storing a customer ID in a visit history storage unit in association with the retailer ID, visit date and time, the price, and the number of people obtained by the customer terminal scanning the scan code.

8. A payment program to be run by a computer that is connected to a customer terminal and a retailer terminal via a network to run, the payment program causing the computer to perform:
a screen generation step of a screen generation unit generating a scan code for making a payment on the basis of a retailer ID, number of people, and price and providing a scan code issuance screen including the scan code; and
an information updating step of an information updating unit storing a customer ID in a visit history storage unit in association with the retailer ID, visit date and time, the price, and the number of people obtained by the customer terminal scanning the scan code.
